(19) United States
(12) Patent Application Publication
(10) Pub. No.: US 2026/0205426 A1
(43) Pub. Date: Jul. 16, 2026

(54) System and Method for Receive Side Scaling (RSS) Imbalance Correction

(71) Applicant: Dell Products L.P., Round Rock, TX (US)

(72) Inventors: Dmitry Krivenok, Dublin (IE); Eldad Zinger, Raanana (IL); Amitai Alkalay, Kadima (IL)

(21) Appl. No.: 19/020,565

(22) Filed: Jan. 14, 2025

(51) Int. Cl. H04L 49/9005; H04L 49/90

(52) U.S. Cl. CPC H04L 49/9005; H04L 49/9068

(57) ABSTRACT

A method, computer program product, and computing system for processing a plurality of network packet flows on a network interface card (NIC) using receive side scaling (RSS). An RSS indirection table is generated for the plurality of network packet flows by assigning each network packet flow to a RSS indirection table slot within the RSS indirection table based upon, at least in part, a hash of the network packet, wherein each RSS indirection table slot includes an assignment to a central processing unit (CPU) core-specific queue. A number of network packet flows is determined per CPU core-specific queue. A balanced RSS indirection table is generated based upon, at least in part, the number of network packet flows per CPU core-specific queue. The plurality of network packet flows from the CPU core-specific queue of the NIC are processed on a CPU core using the balanced RSS indirection table.

### BACKGROUND

Storing and safeguarding electronic content may be beneficial in modern business and elsewhere. Accordingly, various methodologies may be employed to protect and distribute such electronic content.

For example, modern high-performance storage protocols (e.g., NVMe-TCP) employ multi-queue design to achieve the best performance on multi-core machines with constantly increasing number of CPU cores. One unexpected side effect of this is a significant number of connections that storage systems need to deal with and inherent imbalance and misalignment of network and NVMe-TCP protocol processing across CPU cores due to network interface card (NIC) receive side scaling (RSS) design.

### SUMMARY OF DISCLOSURE

In one example implementation, a computer-implemented method executed on a computing device may include, but is not limited to, processing a plurality of network packet flows on a network interface card (NIC) using receive side scaling (RSS). An RSS indirection table is generated for the plurality of network packet flows by assigning each network packet flow to a RSS indirection table slot within the RSS indirection table based upon, at least in part, a hash of the network packet, wherein each RSS indirection table slot includes an assignment to a central processing unit (CPU) core-specific queue. A number of network packet flows is determined per CPU core-specific queue. A balanced RSS indirection table is generated based upon, at least in part, the number of network packet flows per CPU core-specific queue. The plurality of network packet flows from the CPU core-specific queue of the NIC are processed on a CPU core using the balanced RSS indirection table.

One or more of the following example features may be included. Generating the balanced RSS indirection table may include assigning a different CPU core-specific queue to at least a portion of the plurality of RSS indirection table slots. Assigning the different CPU core-specific queue may include assigning the different CPU core-specific queue using a multiway partitioning algorithm. Assigning the different CPU core-specific queue may include sorting a plurality of RSS indirection table slots by the number of network packet flows. Assigning the different CPU core-specific queue may include: assigning the CPU core-specific queue with a current lowest number of network packet flows to the RSS indirection table slot with a largest number of network packet flows; updating the number of network packet flows per CPU core-specific queue; and iteratively assigning the CPU core-specific queue with the current lowest number of network packet flows to the RSS indirection table slot with the next largest number of network packet flows. A plurality of network packet flow rules for the NIC are generated for assigning network packet flows to particular CPU core-specific queues using the balanced RSS indirection table based upon, at least in part, an average number of network packet flows per CPU core-specific queue. A CPU core-specific processing queue is migrated from a first CPU core to a second CPU core for processing a network packet flow within the CPU core-specific queue on the second CPU core.

In another example implementation, a computing system includes at least one processor and at least one memory architecture coupled with the at least one processor, where the at least one processor is configured to process a plurality of network packet flows on a network interface card (NIC) using receive side scaling (RSS). An RSS indirection table is generated for the plurality of network packet flows by assigning each network packet flow to a RSS indirection table slot within the RSS indirection table based upon, at least in part, a hash of the network packet, wherein each RSS indirection table slot includes an assignment to a central processing unit (CPU) core-specific queue. A number of network packet flows is determined per CPU core-specific queue. A balanced RSS indirection table is generated based upon, at least in part, the number of network packet flows per CPU core-specific queue. The plurality of network packet flows from the CPU core-specific queue of the NIC are processed on a CPU core using the balanced RSS indirection table.

One or more of the following example features may be included. Generating the balanced RSS indirection table may include assigning a different CPU core-specific queue to at least a portion of the plurality of RSS indirection table slots. Assigning the different CPU core-specific queue may include assigning the different CPU core-specific queue using a multiway partitioning algorithm. Assigning the different CPU core-specific queue may include sorting a plurality of RSS indirection table slots by the number of network packet flows. Assigning the different CPU core-specific queue may include: assigning the CPU core-specific queue with a current lowest number of network packet flows to the RSS indirection table slot with a largest number of network packet flows; updating the number of network packet flows per CPU core-specific queue; and iteratively assigning the CPU core-specific queue with the current lowest number of network packet flows to the RSS indirection table slot with the next largest number of network packet flows. A plurality of network packet flow rules for the NIC are generated for assigning network packet flows to particular CPU core-specific queues using the balanced RSS indirection table based upon, at least in part, an average number of network packet flows per CPU core-specific queue. A CPU core-specific processing queue is migrated from a first CPU core to a second CPU core for processing a network packet flow within the CPU core-specific queue on the second CPU core.

In another example implementation, a computer program product resides on a computer readable medium that has a plurality of instructions stored on it. When executed by a processor, the instructions cause the processor to perform operations that may include, but are not limited to, processing a plurality of network packet flows on a network interface card (NIC) using receive side scaling (RSS). An RSS indirection table is generated for the plurality of network packet flows by assigning each network packet flow to a RSS indirection table slot within the RSS indirection table based upon, at least in part, a hash of the network packet, wherein each RSS indirection table slot includes an assignment to a central processing unit (CPU) core-specific queue. A number of network packet flows is determined per CPU core-specific queue. A balanced RSS indirection table is generated based upon, at least in part, the number of network packet flows per CPU core-specific queue. The plurality of network packet flows from the CPU core-specific queue of the NIC are processed on a CPU core using the balanced RSS indirection table.

One or more of the following example features may be included. Generating the balanced RSS indirection table may include assigning a different CPU core-specific queue to at least a portion of the plurality of RSS indirection table slots. Assigning the different CPU core-specific queue may include assigning the different CPU core-specific queue using a multiway partitioning algorithm. Assigning the different CPU core-specific queue may include sorting a plurality of RSS indirection table slots by the number of network packet flows. Assigning the different CPU core-specific queue may include: assigning the CPU core-specific queue with a current lowest number of network packet flows to the RSS indirection table slot with a largest number of network packet flows; updating the number of network packet flows per CPU core-specific queue; and iteratively assigning the CPU core-specific queue with the current lowest number of network packet flows to the RSS indirection table slot with the next largest number of network packet flows. A plurality of network packet flow rules for the NIC are generated for assigning network packet flows to particular CPU core-specific queues using the balanced RSS indirection table based upon, at least in part, an average number of network packet flows per CPU core-specific queue. A CPU core-specific processing queue is migrated from a first CPU core to a second CPU core for processing a network packet flow within the CPU core-specific queue on the second CPU core.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a receive side scaling (RSS) balancing process coupled to a distributed computing network according to one or more example implementations of the disclosure;

FIG. 2 is an example diagrammatic view of the storage system of FIG. 1 according to one or more example implementations of the disclosure;

FIG. 3 is an example flowchart of the RSS balancing process of FIG. 1 according to one or more example implementations of the disclosure;

FIG. 4 is an example diagrammatic view of the RSS balancing process; and

FIG. 5 is an example diagrammatic view of the generation of an RSS indirection table according to one or more example implementations of the disclosure.

Like reference symbols in the various drawings indicate like elements.

### DETAILED DESCRIPTION

### System Overview:

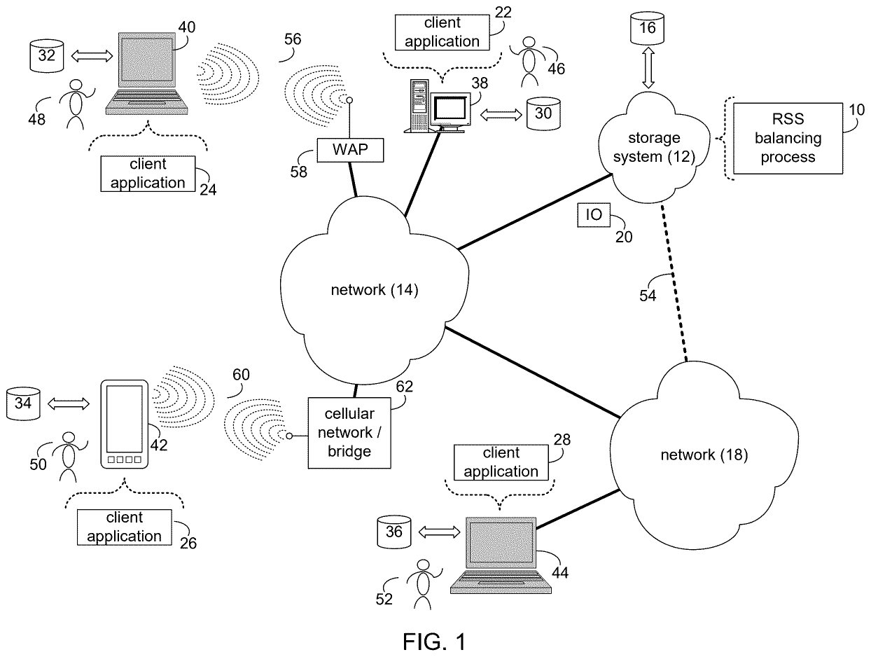

Referring to FIG. 1, there is shown receive side scaling (RSS) balancing process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a minicomputer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of RSS balancing process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random-access memory (RAM); a read-only memory (ROM); and all forms of flash memory storage devices. Additionally/alternatively, some portions of the instruction sets and subroutines of RSS balancing process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a receive side scaling (RSS) balancing process, such as RSS balancing process 10 of FIG. 1, may include but is not limited to, processing a plurality of network packet flows on a network interface card (NIC) using receive side scaling (RSS). An RSS indirection table is generated for the plurality of network packet flows by assigning each network packet flow to a RSS indirection table slot within the RSS indirection table based upon, at least in part, a hash of the network packet, wherein each RSS indirection table slot includes an assignment to a central processing unit (CPU) core-specific queue. A number of network packet flows is determined per CPU core-specific queue. A balanced RSS indirection table is generated based upon, at least in part, the number of network packet flows per CPU core-specific queue. The plurality of network packet flows from the CPU core-specific queue of the NIC are processed on a CPU core using the balanced RSS indirection table.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System:

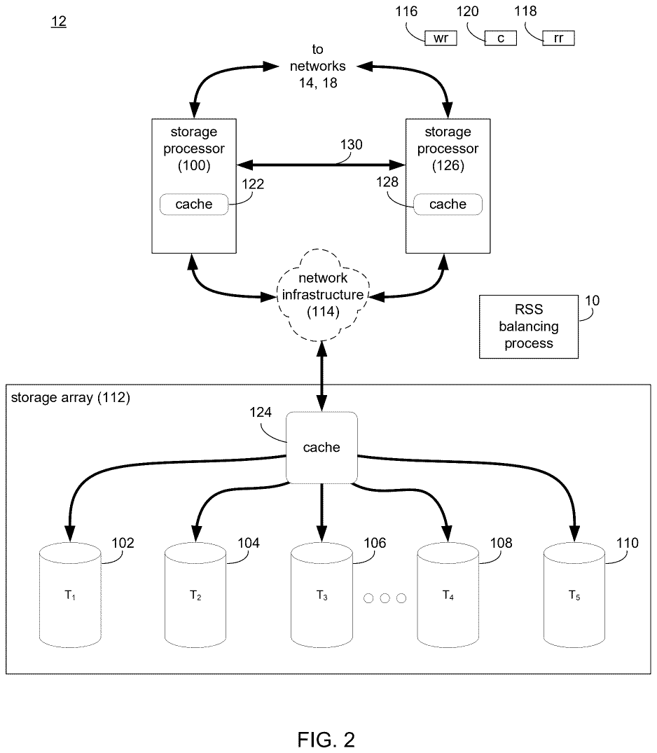

Referring also to FIG. 2, storage system 12 may include storage processor 100 and a plurality of storage targets T 1−n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g. storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g. the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g. the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of RSS balancing process 10. The instruction sets and subroutines of RSS balancing process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random-access memory (RAM); a read-only memory (ROM); and all forms of flash memory storage devices. As discussed above, some portions of the instruction sets and subroutines of RSS balancing process 10 may be stored on storage devices (and/or executed by processors and memory architectures) that are external to storage system 12.

As discussed above, various IO requests (e.g. IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e. a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g. one or more of storage targets 102, 104, 106, 108, and coded target 110.

As discussed above, the instruction sets and subroutines of RSS balancing process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of RSS balancing process 10 may be executed by one or more processors (not shown) and one or more memory architectures (not shown) included within data array 112.

Further and as discussed above, during the operation of data array 112, content (e.g., content 118) to be written to data array 112 may be received from storage processor 100 and initially stored within backend cache memory system 124 prior to being stored on e.g. one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

In some implementations, storage system 12 may include multi-node active/active storage clusters configured to provide high availability to a user. As is known in the art, the term “high availability” may generally refer to systems or components that are durable and likely to operate continuously without failure for a long time. For example, an active/active storage cluster may be made up of at least two nodes (e.g., storage processors 100, 126), both actively running the same kind of service(s) simultaneously. One purpose of an active-active cluster may be to achieve load balancing. Load balancing may distribute workloads across all nodes in order to prevent any single node from getting overloaded. Because there are more nodes available to serve, there will also be a marked improvement in throughput and response times. Another purpose of an active-active cluster may be to provide at least one active node in the event that one of the nodes in the active-active cluster fails.

In some implementations, storage processor 126 may function like storage processor 100. For example, during operation of storage processor 126, content 118 to be written to storage system 12 may be processed by storage processor 126. Additionally/alternatively and when storage processor 126 is configured as an application server, content 118 to be written to storage system 12 may be internally generated by storage processor 126.

Storage processor 126 may include frontend cache memory system 128. Examples of frontend cache memory system 128 may include but are not limited to a volatile, solid-state, cache memory system (e.g., a dynamic RAM cache memory system) and/or a non-volatile, solid-state, cache memory system (e.g., a flash-based, cache memory system).

Storage processor 126 may initially store content 118 within frontend cache memory system 126. Depending upon the manner in which frontend cache memory system 128 is configured, storage processor 126 may immediately write content 118 to data array 112 (if frontend cache memory system 128 is configured as a write-through cache) or may subsequently write content 118 to data array 112 (if frontend cache memory system 128 is configured as a write-back cache).

In some implementations, the instruction sets and subroutines of RSS balancing process 10, which may be stored on storage device 16 included within storage system 12, may be executed by one or more processors (not shown) and one or more memory architectures (not shown) included within storage system 12. Accordingly, in addition to being executed on storage processor 126, some or all of the instruction sets and subroutines of RSS balancing process 10 may be executed by one or more processors (not shown) and one or more memory architectures (not shown) included within data array 112.

Further and as discussed above, during the operation of data array 112, content (e.g., content 118) to be written to data array 112 may be received from storage processor 126 and initially stored within backend cache memory system 124 prior to being stored on e.g. one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

As discussed above, storage processor 100 and storage processor 126 may be configured in an active/active configuration where the processing of data by one storage processor may be synchronized to the other storage processor. For example, data may be synchronized between each storage processor via a separate link or connection (e.g., connection 130).

### The Receive Side Scaling (RSS) Balancing Process:

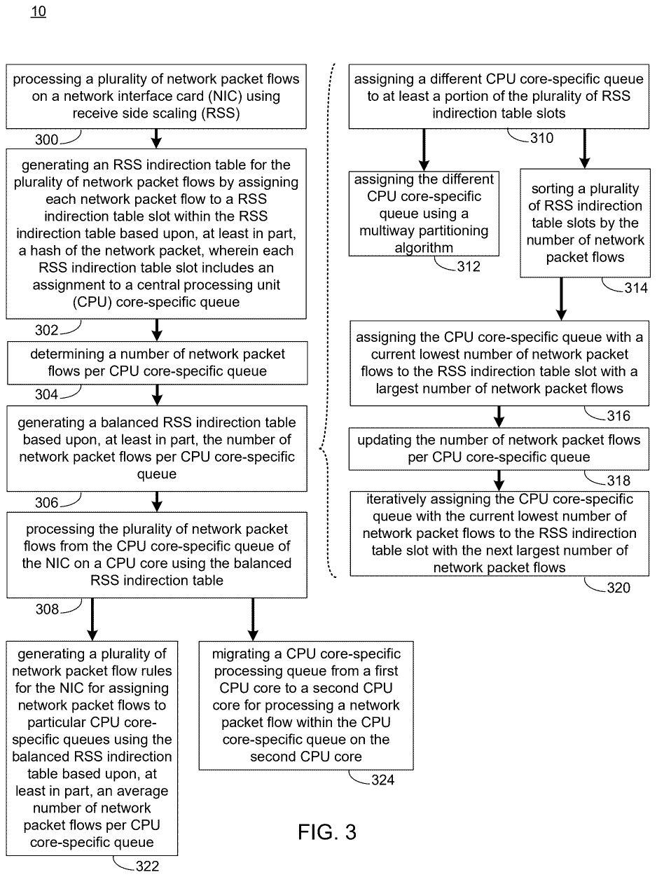

Referring also to FIGS. 3-5 and in some implementations, RSS balancing process 10 may include processing 300 a plurality of network packet flows on a network interface card (NIC) using receive side scaling (RSS). An RSS indirection table is generated 302 for the plurality of network packet flows by assigning each network packet flow to a RSS indirection table slot within the RSS indirection table based upon, at least in part, a hash of the network packet, wherein each RSS indirection table slot includes an assignment to a central processing unit (CPU) core-specific queue. A number of network packet flows is determined 304 per CPU core-specific queue. A balanced RSS indirection table is generated 306 based upon, at least in part, the number of network packet flows per CPU core-specific queue. The plurality of network packet flows from the CPU core-specific queue of the NIC are processed 308 on a CPU core using the balanced RSS indirection table.

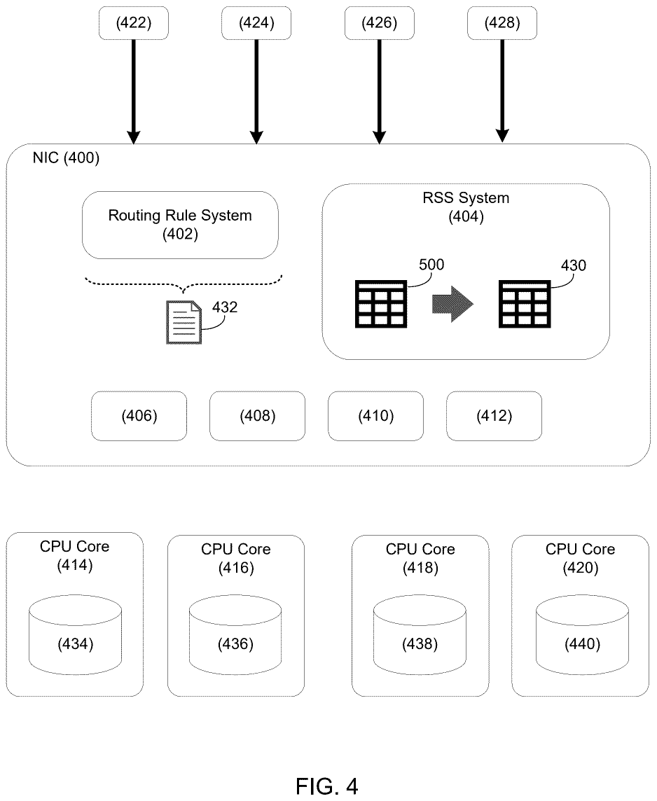

In some implementations, RSS balancing process 10 processes 300 a plurality of network packet flows on a network interface card (NIC) using receive side scaling (RSS). For example and as shown in FIG. 4, a network interface card (NIC) (e.g., NIC 400) processes network packets from various computing devices within a network-connected storage system (as shown in FIG. 1). In network-connected storage systems, such as Network Attached Storage (NAS), the NIC (e.g., NIC 400) is responsible for handling network traffic, which includes both server and user data in the form of flows of network packets (e.g., network packet flows). As shown in FIG. 4, NIC 400 includes routing rule system 402, RSS system 404, and a plurality of CPU core-specific queues (e.g., CPU core-specific queues 406, 408, 410, 412) for routing network packet flows to particular CPU cores (e.g., CPU cores 414, 416, 418, 420) within storage system 12 (e.g., within storage processor 100 or storage processor 126). Routing rule system 402 is a hardware and/or software component that manages various rules or processing logic that is predefined within NIC 400 for routing particular network packet flows to specific CPU core-specific queues. As such, when a network packet flow is processed by NIC 400, RSS balancing process 10 determines whether the network packet flow CPU core-specific queue assignment is predefined by routing rule system 402. If there is a rule in routing rule system 402, RSS balancing process 10 applies the rule to assign the network packet flow to the specified CPU core-specific queue. In one example, routing rule system 402 is adaptive Receive Flow Steering (aRFS). aRFS is a network packet processing approach that steers network packet flows to particular CPU cores by mapping each network packet to a specific CPU core that adapts in real-time to changing traffic patterns. In this example, identifying a rule in routing rule system 402 for a given network packet flow is an “aRFS rule hit”. If there is not a rule, RSS balancing process 10 processes 300 the network packet flow using RSS system 404. In the example of aRFS, the absence of a rule is an “aRFS miss”.

To ensure effective processing of network packet flows in a multi-core central processing unit (CPU), Receive Side Scaling (RSS) system 404 is a hardware and/or software component that distributes the network packet flows across multiple CPU cores. In some implementations, RSS system 404 is non-deterministic because the assignment of a network packet flow to a particular CPU core-specific queue is based on packet headers from the network packet flow (e.g., MAC addresses, IP addresses, TCP/UDP ports, etc.).

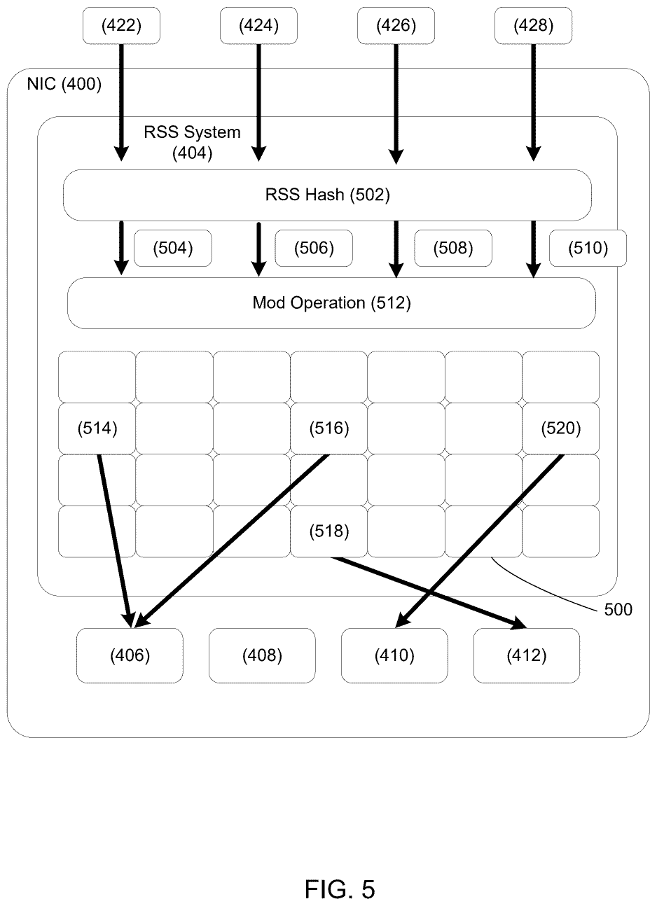

In some implementations, RSS balancing process 10 generates 302 an RSS indirection table for the plurality of network packet flows by assigning each network packet flow to a RSS indirection table slot within the RSS indirection table based upon, at least in part, a hash of the network packet, wherein each RSS indirection table slot includes an assignment to a CPU core-specific queue. For example and as shown in FIG. 5, RSS balancing process 10 generates 302 an RSS indirection table (e.g., RSS indirection table 500) with a plurality of RSS indirection table slots that map a particular CPU core-specific queue assignment. During processing of the network packet flows from NIC 400 on the plurality of CPU cores 414, 416, 418, 420, the CPU core-specific queue (e.g., CPU core-specific queues 406, 408, 410, 412) interrupts a CPU core with a network packet flow to process. In some implementations, each CPU core-specific queue is connected to a CPU core using an affinity mask (i.e., a bit mask that indicates which CPU cores a thread or network packet flow should be run on by a CPU operating system's scheduler).

As shown in FIGS. 4-5, a plurality of network packet flows (e.g., network packet flows 422, 424, 426, 428) are processed 300 by NIC 400. RSS balancing process 10 extracts headers from the incoming network packet flows and calculates a hash value using a supported hash function. One example of the hash function is the Toeplitz hash function by default, but other hash functions may be supported. The calculated hash value is used by RSS balancing process 10 to derive an index in RSS indirection table 500 by using a “mod” operation. The size of the RSS indirection table 500 is usually fixed and depends on the specific model of the NIC. Each slot in the table includes a CPU core-specific queue number, where the network packet flow will be directed. In some implementations, all CPU core-specific queues have equal weights. In some implementations, indirection table may be programmed to define non equal weights for the CPU core-specific queues.

However, RSS system 404 is inherently incapable of achieving perfect balance across CPU core-specific queues of NIC 400 because it is based on hashing of the network packet headers. In addition to imbalance across CPU core-specific queues (and resulting CPU cores handling interrupts), RSS behavior naturally causes misalignment of flow processing when initial processing happens on one CPU core, but protocol processing happens on another core. For example and as shown in the example of FIG. 5, RSS balancing process 10 uses a hash function (e.g., hash function 502) to generate hash value 504 for network packet flow 422; hash value 506 for network packet flow 424; hash value 508 for network packet flow 426; and hash value 510 for network packet flow 428. RSS balancing process 10 uses a mod operation (e.g., mod operation 512) to map hash value 504 to RSS indirection table slot 514; hash value 506 to RSS indirection table slot 516; hash value 508 to RSS indirection table slot 518; and hash value 510 to RSS indirection table slot 520. In this example, RSS indirection table slot 514 maps to CPU core-specific queue 406; RSS indirection table slot 516 maps to CPU core-specific queue 406; RSS indirection table slot 518 maps to CPU core-specific queue 412; and RSS indirection table slot 520 maps to CPU core-specific queue 410. In this example, network packet flows 422, 424 are mapped to the same CPU core-specific queue (e.g., CPU core-specific queue 406) via RSS indirection table slots 514, 516. As shown in this example, RSS system 404 provides imbalanced network packet flow processing to CPU core-specific queues. In some implementations and as will be discussed in greater detail below, RSS balancing process 10 reduces the number of aRFS rules required to achieve balancing of network packet flows across CPU core-specific queues by improving the way RSS works.

In some implementations, RSS balancing process 10 determines 304 a number of network packet flows per CPU core-specific queue. For example, RSS balancing process 10 obtains or calculates RSS hash as described above for every network packet flow. With the RSS hash, RSS balancing process 10 calculates the RSS indirection table slot numbers for every network packet flow. RSS balancing process 10 queries the current RSS indirection table and calculates the number of network packet flows per each CPU core-specific queues. In one example, Table 1 shows the CPU core-specific queue assignment and number of network packet flows for each RSS indirection table slot and Table 2 shows a number of network packet flows per CPU core-specific queue:

TABLE 1

| | | Number of network |
|---|---|---|
| RSS indirection table slot | CPU core-specific queue | packet flows |
| 0 | 0 | 231 |
| 1 | 1 | 211 |
| 2 | 2 | 256 |
| . . . | | . . . |
| S-1 | 3 | 272 |

| | |
|---|---|
| Total | 2440 |

TABLE 2

| | Number of network | |
|---|---|---|
| CPU core-specific queue | packet flows | Difference with average |
| 0 | 530 | −80 |
| 1 | 649 | 39 |
| 2 | 562 | −48 |
| 3 | 699 | 89 |
| Total | 2440 | 0 |

| | |
|---|---|
| Rules required for complete balance | 128 = 39 + 89 |

In some implementations, RSS balancing process 10 generates 306 a balanced RSS indirection table based upon, at least in part, the number of network packet flows per CPU core-specific queue. For example, RSS balancing process 10 generates a balanced RSS indirection table (e.g., balanced RSS indirection table 430) by managing the assignment of CPU core-specific queues to particular RSS indirection table slots. NICs support reconfiguration of the RSS indirection table slots, but usually this feature is only used to dedicate more slots to certain CPU core-specific queues while still fully relying on RSS hash. Implementations of the present disclosure considers information about RSS indirection table slots where network packet flows are routed. This allows RSS balancing process 10 to modify RSS indirection table slots so that RSS system 404 provides almost balanced configuration across CPU core-specific queues. Accordingly, only a small number of network packet flow rules are used to improve a nearly balanced configuration to a completely balanced configuration.

In some implementations, generating 306 the balanced RSS indirection table includes assigning 310 a different CPU core-specific queue to at least a portion of the plurality of RSS indirection table slots. For example, as the RSS hash is defined by RSS system 404, RSS balancing process 10 does not modify the RSS has but generates a new RSS indirection table by assigning different CPU core-specific queues to particular RSS indirection table slots. As will be discussed in greater detail below, RSS balancing process 10 assigns the CPU core-specific queues to particular RSS indirection table slots using the number of network packet flows per CPU core-specific queue (as shown in Table 2).

In some implementations, assigning 310 the different CPU core-specific queue includes assigning 312 the different CPU core-specific queue using a multiway partitioning algorithm. A multiway partitioning algorithm is a computational method used to divide a set of items into multiple subsets, optimizing certain criteria. In some implementations, RSS balancing process 10 assigns 312 the different CPU core-specific queue to the balanced RSS indirection table slots includes performing a multiway partitioning algorithm by partitioning “S” balanced RSS indirection table slots into “M” groups with the goal of achieving as equal groups as possible with weighting balanced RSS indirection table slots by the number of network packet flows.

In some implementations, assigning 310 the different CPU core-specific queue includes: sorting 314 a plurality of RSS indirection table slots by the number of network packet flows; assigning 316 the CPU core-specific queue with a current lowest number of network packet flows to the RSS indirection table slot with a largest number of network packet flows; updating 318 the number of network packet flows per CPU core-specific queue; and iteratively assigning 320 the CPU core-specific queue with the current lowest number of network packet flows to the RSS indirection table slot with the next largest number of network packet flows. For example, RSS balancing process 10 sorts 314 the RSS indirection table slots by the number of network packet flows. In some implementations, RSS balancing process 10 iterates over all RSS indirection table slots starting from the slot with the largest number of network packet flows. At each iteration, RSS balancing process 10 selects a CPU core-specific queue with the lowest number of network packet flows. This CPU core-specific queue is assigned to the balanced RSS indirection table in the current slot, and receives all network packet flows of this slot (as defined by the hash function). At every iteration, network packet flows are contributed to the CPU core-specific queue with the smallest number of network packet slots thus far. In this manner, RSS balancing process 10 assigns 316 the CPU core-specific queue with a current lowest number of network packet flows to the RSS indirection table slot with the largest number of network packet flows. RSS balancing process 10 updates 318 the number of network packet flows per CPU core-specific queue and iteratively assigns 320 the updated CPU core-specific queue with the current lowest number of network packet flows to the RSS indirection table slot with the next largest number of network packet flows. In this example, RSS balancing process 10 yields a balanced (or nearly balanced) configuration in most instances as shown in Tables 3 and 4, using the example of Tables 1 and 2:

TABLE 3

| Balanced RSS indirection | | Number of network |
|---|---|---|
| table slot | CPU core-specific queue | packet flows |
| 0 | 3 | 231 |
| 1 | 3 | 211 |
| 2 | 1 | 256 |
| . . . | | . . . |
| S-1 | 0 | 272 |

| | |
|---|---|
| Total | 2440 |

TABLE 4

| | Number of network | |
|---|---|---|
| CPU core-specific queue | packet flows | Difference with average |
| 0 | 599 | −11 |
| 1 | 604 | −6 |
| 2 | 620 | 10 |
| 3 | 617 | 7 |
| Total | 2440 | 0 |

| | |
|---|---|
| Rules required for complete balance | 17 = 10 + 7 |

With this approach, RSS balancing process 10 generates 306 a balanced RSS indirection table with a different configuration of CPU core-specific queues across RSS indirection table slots. As shown above in Table 3, each RSS indirection table slot still maintains the same number of flows, but as shown in Table 4, the number of network packet flows per CPU core-specific queue is rebalanced.

In some implementations, RSS balancing process 10 generates 322 a plurality of network packet flow rules for the NIC for assigning network packet flows to particular CPU core-specific queues using the balanced RSS indirection table based upon, at least in part, an average number of network packet flows per CPU core-specific queue. For example and as shown in the example of Table 4, RSS balancing process 10 determines that 17 additional network packet flow rules will result in complete balancing of the plurality of network packet flows among the CPU core-specific queues. Accordingly, RSS balancing process 10 processes the CPU core-specific queues with the number of flows above average and generates per-flow network packet flow rules directing traffic to CPU core-specific queues with a number of flows below the average. In some implementations, RSS balancing process 10 generates the plurality of network packet flow rules (e.g., network packet flow rules 432) and provides these to routing rule system 402. In this manner, RSS balancing process 10 generates an ideally balanced configuration with much smaller number of rules than is normally needed (e.g., comparing Table 2's 128 rules required for balance with Table 4's 17 rules required for balance).

In some implementations, RSS balancing process 10 processes 308 the plurality of network packet flows from the CPU core-specific queue of the NIC on a CPU core using the balanced RSS indirection table. For example, RSS balancing process 10 uses balanced RSS indirection table 430 to process 308 the plurality of network packet flows (e.g., network packet flows 422, 424, 426, 428) from CPU core-specific queues 406, 408, 410, 412 of NIC 400 on CPU cores 414, 416, 418, 420. In some implementations, RSS balancing process 10 uses the newly generated network packet flow rules to achieve complete balance as shown in Table 4.

In some implementations, RSS balancing process 10 migrates 324 a CPU core-specific processing queue from a first CPU core to a second CPU core for processing a network packet flow within the CPU core-specific queue on the second CPU core. For example, the above description of RSS balancing process 10 resolves the CPU core-specific queue imbalance problem using RSS imbalance correction together with network packet flow rules, but there is a misalignment issue. Accordingly, RSS balancing process 10 migrates 324 the CPU core-specific processing queues between CPUs. A CPU core-specific processing queue is a separate queue from the CPU core-specific queues of NIC 400 but are associated with each CPU and manage the processing of threads or network packet flows on a specific CPU core. In one example, a CPU core-specific processing queue is an NVMe-TCP IO queue associated with processing input/output (IO) operations on various CPU cores according to the NVMe-TCP protocol. In some implementations, a computing device may examine the incoming CPU of the network packet flow corresponding to each CPU core-specific processing queue (e.g., CPU core-specific processing queue 434 for CPU core 414; CPU core-specific processing queue 436 for CPU core 416; CPU core-specific processing queue 438 for CPU core 418; and CPU core-specific processing queue 440 for CPU core 420) and migrate 324 the CPU core-specific processing queue from a current CPU to the CPU of the network packet flow if it is different from the current CPU. In some implementations, the migration of the queues may be target-specific and may be implemented by changing ownership of the queue. In another example, RSS balancing process 10 migrates the target thread to a different CPU by changing a CPU affinity mask. Accordingly, it will be appreciated that RSS balancing process 10 can provide different migration approaches to resolve the misalignment issue among CPU core-specific processing queues and the target CPU cores of a network packet flow.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
processing a plurality of network packet flows on a network interface card (NIC) using receive side scaling (RSS);
generating an RSS indirection table for the plurality of network packet flows by assigning each network packet flow to a RSS indirection table slot within the RSS indirection table based upon, at least in part, a hash of the network packet, wherein each RSS indirection table slot includes an assignment to a central processing unit (CPU) core-specific queue;
determining a number of network packet flows per CPU core-specific queue;
generating a balanced RSS indirection table based upon, at least in part, the number of network packet flows per CPU core-specific queue; and
processing the plurality of network packet flows from the CPU core-specific queue of the NIC on a CPU core using the balanced RSS indirection table.

2. The computer-implemented method of claim 1, wherein generating the balanced RSS indirection table includes assigning a different CPU core-specific queue to at least a portion of the plurality of RSS indirection table slots.

3. The computer-implemented method of claim 2, wherein assigning the different CPU core-specific queue includes assigning the different CPU core-specific queue using a multiway partitioning algorithm.

4. The computer-implemented method of claim 2, wherein assigning the different CPU core-specific queue includes sorting a plurality of RSS indirection table slots by the number of network packet flows.

5. The computer-implemented method of claim 1, wherein assigning the different CPU core-specific queue includes:
assigning the CPU core-specific queue with a current lowest number of network packet flows to the RSS indirection table slot with a largest number of network packet flows;
updating the number of network packet flows per CPU core-specific queue; and
iteratively assigning the CPU core-specific queue with the current lowest number of network packet flows to the RSS indirection table slot with the next largest number of network packet flows.

6. The computer-implemented method of claim 1, further comprising:
generating a plurality of network packet flow rules for the NIC for assigning network packet flows to particular CPU core-specific queues using the balanced RSS indirection table based upon, at least in part, an average number of network packet flows per CPU core-specific queue.

7. The computer-implemented method of claim 1, further comprising:
migrating a CPU core-specific processing queue from a first CPU core to a second CPU core for processing a network packet flow within the CPU core-specific queue on the second CPU core.

8. A computing system comprising:
a memory; and
a processor configured to:
process a plurality of network packet flows on a network interface card (NIC) using receive side scaling (RSS);
generate an RSS indirection table for the plurality of network packet flows by assigning each network packet flow to a RSS indirection table slot within the RSS indirection table based upon, at least in part, a hash of the network packet, wherein each RSS indirection table slot includes an assignment to a central processing unit (CPU) core-specific queue;
determine a number of network packet flows per CPU core-specific queue;
generate a balanced RSS indirection table based upon, at least in part, the number of network packet flows per CPU core-specific queue; and
process the plurality of network packet flows from the CPU core-specific queue of the NIC on a CPU core using the balanced RSS indirection table.

9. The computing system of claim 8, wherein generating the balanced RSS indirection table includes assigning a different CPU core-specific queue to at least a portion of the plurality of RSS indirection table slots.

10. The computing system of claim 9, wherein assigning the different CPU core-specific queue includes assigning the different CPU core-specific queue using a multiway partitioning algorithm.

11. The computing system of claim 9, wherein assigning the different CPU core-specific queue includes sorting a plurality of RSS indirection table slots by the number of network packet flows.

12. The computing system of claim 10, wherein assigning the different CPU core-specific queue includes:
assigning the CPU core-specific queue with a current lowest number of network packet flows to the RSS indirection table slot with a largest number of network packet flows;
updating the number of network packet flows per CPU core-specific queue; and
iteratively assigning the CPU core-specific queue with the current lowest number of network packet flows to the RSS indirection table slot with the next largest number of network packet flows.

13. The computing system of claim 8, wherein the processor is further configured to:
generate a plurality of network packet flow rules for the NIC for assigning network packet flows to particular CPU core-specific queues using the balanced RSS indirection table based upon, at least in part, an average number of network packet flows per CPU core-specific queue.

14. The computing system of claim 8, wherein the processor is further configured to:
migrate a CPU core-specific processing queue from a first CPU core to a second CPU core for processing a network packet flow within the CPU core-specific queue on the second CPU core.

15. A computer program product residing on a non-transitory computer readable medium having a plurality of instructions stored thereon which, when executed by a processor, cause the processor to perform operations comprising:
processing a plurality of network packet flows on a network interface card (NIC) using receive side scaling (RSS);
generating an RSS indirection table for the plurality of network packet flows by assigning each network packet flow to a RSS indirection table slot within the RSS indirection table based upon, at least in part, a hash of the network packet, wherein each RSS indirection table slot includes an assignment to a central processing unit (CPU) core-specific queue;
determining a number of network packet flows per CPU core-specific queue;
generating a balanced RSS indirection table based upon, at least in part, the number of network packet flows per CPU core-specific queue; and
processing the plurality of network packet flows from the CPU core-specific queue of the NIC on a CPU core using the balanced RSS indirection table.

16. The computer program product of claim 15, wherein generating the balanced RSS indirection table includes assigning a different CPU core-specific queue to at least a portion of the plurality of RSS indirection table slots.

17. The computer program product of claim 16, wherein assigning the different CPU core-specific queue includes assigning the different CPU core-specific queue using a multiway partitioning algorithm.

18. The computer program product of claim 16, wherein assigning the different CPU core-specific queue includes sorting a plurality of RSS indirection table slots by the number of network packet flows.

19. The computer program product of claim 15, wherein assigning the different CPU core-specific queue includes:
assigning the CPU core-specific queue with a current lowest number of network packet flows to the RSS indirection table slot with a largest number of network packet flows;
updating the number of network packet flows per CPU core-specific queue; and
iteratively assigning the CPU core-specific queue with the current lowest number of network packet flows to the RSS indirection table slot with the next largest number of network packet flows.

20. The computer program product of claim 15, wherein the operations further comprise:
generating a plurality of network packet flow rules for the NIC for assigning network packet flows to particular CPU core-specific queues using the balanced RSS indirection table based upon, at least in part, an average number of network packet flows per CPU core-specific queue.
